(19) United States
(12) Patent Application Publication
(10) Pub. No.: US 2011/0226554 A1
(43) Pub. Date: Sep. 22, 2011

(54) ADJUSTABLE SCAFFOLD LADDER BRACKET APPARATUS

(76) Inventor: Patrick K. Anderson, Prairieville, LA (US)

(21) Appl. No.: 12/672,258

(22) PCT Filed: Aug. 8, 2008
(86) PCT No.: PCT/US2008/072605

§ 371 Date: Feb. 4, 2010

Related U.S. Application Data
(60) Provisional application No. 60/954,705, filed on Aug. 8, 2007.

(51) Int. Cl. E04G 1/00; F16M 13/02; F16B 2/02

(52) U.S. Cl. 182/222; 248/226.11

(57) ABSTRACT

The present invention provides an adjustable ladder and scaffolding system wherein a scaffolding structure provides a support to which is attached a frame. The frame includes a pair of ladder clamps that enable the frame to be connected to the spaced apart risers of a ladder that is to be supported. The frame includes left and right plates and a base opposite the ladder clamps. Adjustable connections are provided between the left and right plates and the base so that the distance between the base and the clamps can be varied, thus enabling the ladder to assume a diagonally extending orientation relative to horizontal. The frame is adjustable so that each frame attached to the ladder shortens the distance between the ladder and the scaffolding structure as the elevation is increased.

### CROSS-REFERENCE TO RELATED APPLICATIONS

Priority of U.S. Provisional Patent Application Ser. No. 60/954,705, filed 8 Aug. 2007, incorporated herein by reference, is hereby claimed.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

1. Field of the Invention

The present invention relates to scaffolding ladders. More particularly, the present invention relates to an improved scaffold ladder bracket apparatus that enables the angle of inclination of the ladder to be adjusted relative to the scaffolding with which it is associated.

2. General Background of the Invention

Scaffolding is commonly used in construction to enable workers to perform their trades at elevated positions. In order to gain access to the upper levels of scaffolding, ladders are provided that are attached to scaffolding. Typically, the scaffolding is constructed of vertical members to which horizontal levels are attached. Presently, ladders are attached to these vertical portions of the scaffolding. Thus, the ladders are also generally vertically oriented. Ladders that are purely vertical in orientation are not as easy to climb and are not as safe as a ladder that has been inclined a number of degrees.

The following possibly relevant US patents are incorporated herein by reference:

TABLE

| | | ISSUE DATE |
|---|---|---|
| Pat. No. | TITLE | MM/DD/YYYY |
| 2,140,828 | Combination Ladder Bracket | 12-20-1938 |
| 3,741,510 | Ladder Support Spacer | 06-26-1973 |
| 3,762,500 | Ladder | 10-02-1973 |
| 4,086,979 | Scaffold Ladder Adapter | 05-02-1978 |
| GB 2,222,629 | A Ladder/Scaffold Clamp | 03-14-1990 |
| 6,044,930 | Stabilizing Bracket for a Ladder | 04-04-2000 |
| | or the Like | |
| GB 2,383,074 | Scaffold Gate | 06-18-2003 |
| US2003/0127283 | Adjustable Scaffold and | 07-10-2003 |
| | Walkboard Ladder Holder | |

### BRIEF SUMMARY OF THE INVENTION

The present invention provides an adjustable ladder and scaffolding system wherein a scaffolding structure provides a support to which is attached a frame. The frame includes a pair of ladder clamps that enable the frame to be connected to the spaced apart risers of a ladder that is to be supported. The frame includes left and right plates and a base opposite the ladder clamps. Adjustable connections are provided between the left and right plates and the base so that the distance between the base and the clamps can be varied, thus enabling the ladder to assume a diagonally extending orientation relative to horizontal. The frame is adjustable so that each frame attached to the ladder shortens the distance between the ladder and the scaffolding structure as the elevation is increased.

### BRIEF DESCRIPTION OF THE SEVERAL VIEWS OF THE DRAWINGS

For a further understanding of the nature, objects, and advantages of the present invention, reference should be had to the following detailed description, read in conjunction with the following drawings, wherein like reference numerals denote like elements and wherein:

FIG. 1 is a perspective exploded view of the preferred embodiment of the apparatus of the present invention;

FIG. 2 is a partial perspective view of the preferred embodiment of the apparatus of the present invention;

FIG. 3 is another partial perspective view of the preferred embodiment of the apparatus of the present invention;

FIG. 4 is a partial elevation view of the preferred embodiment of the apparatus of the present invention; and

FIG. 5 is another elevation view of the preferred embodiment of the apparatus of the present invention.

### DETAILED DESCRIPTION OF THE INVENTION

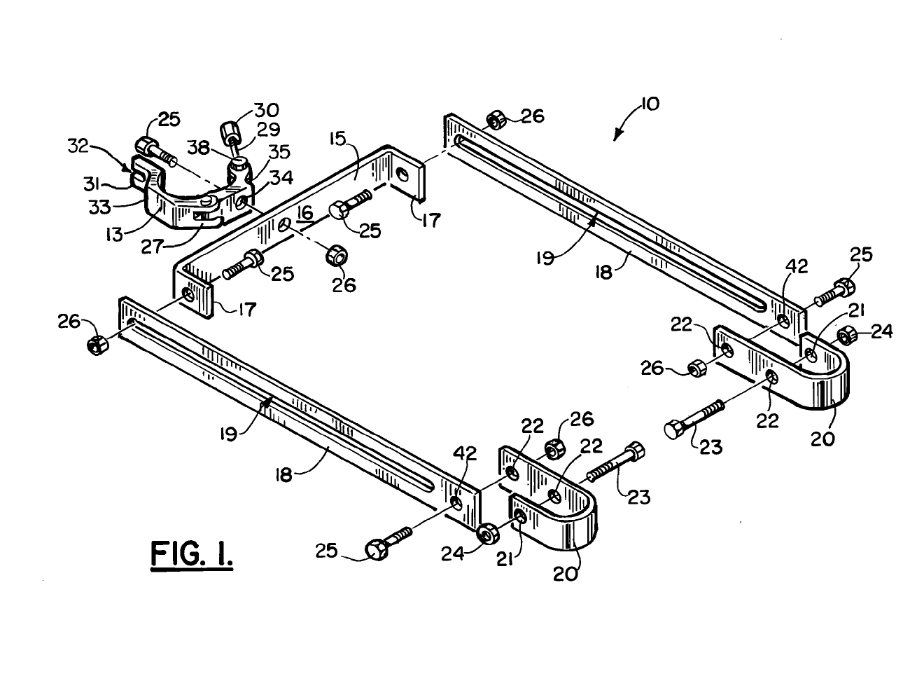

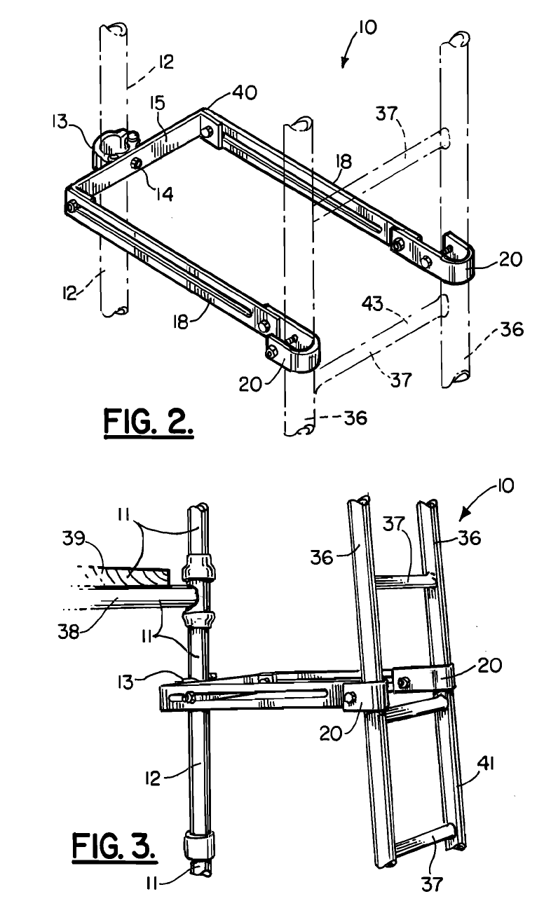

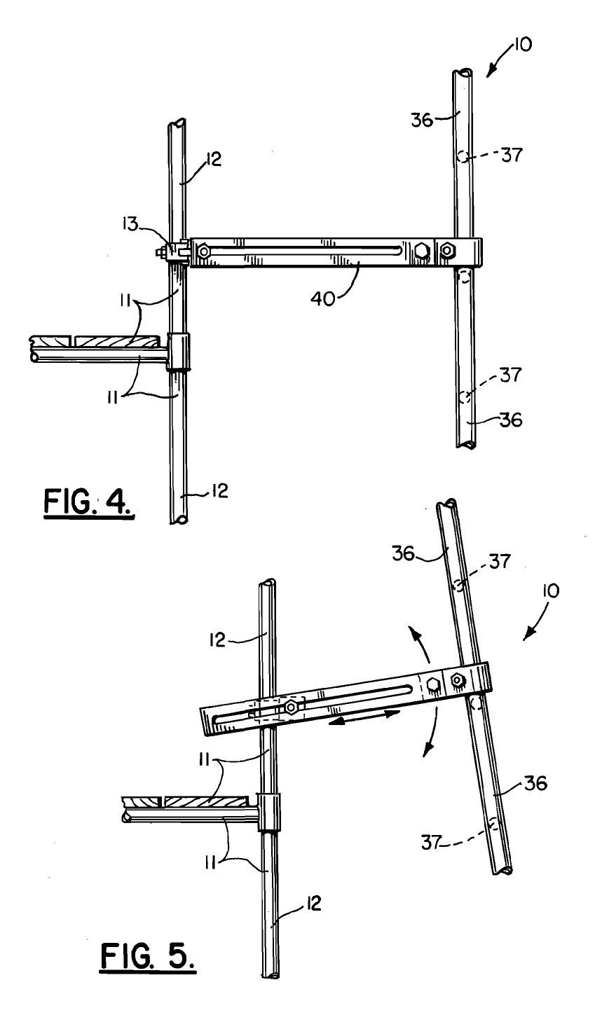

FIGS. 1-5 show the preferred embodiment of the apparatus of the present invention, designated generally by the numeral 10. Ladder support apparatus 10 is shown in FIGS. 2-4 attached to scaffolding 11. The scaffolding 11 typically provides one or more inclined or vertical members 12 to which horizontal sections or members 38 that are covered with flooring 39 are attached. In FIG. 3, for example, horizontal members 38 supports wood flooring 39.

A clamp 13 attaches with a bolted connection 14 to a generally rectangular frame 40. The frame 40 includes a laterally extended bracket 15 to which clamp 13 is connected with bolting using bolt 25 and nut 24, for example. The laterally extending bracket 15 includes a web 16 and a pair of flanges 17 that are spaced apart, as shown in FIG. 1. A pair of elongated plates 18 are attached to laterally extended bracket 15, each plate 18 attaching to a flange 17 using a bolted connection, using bolt 25 and nut 24, for example. Each elongated plate 18 preferably provides an elongated slot 19.

A pair of j-shaped members 20 are attached respectively to plates 18, and at a position generally opposite flanges 17 as shown in FIGS. 1 and 2. Each j-shaped member 20 provides an opening 21 on one of the legs of the j-shaped member 20 and a pair of openings 22 on the other of the legs of the j-shaped member 20.

A scaffolding ladder 41 attaches to frame 40 (see FIGS. 2-5). Ladder 41 provides a pair of spaced apart risers 36 and a plurality of rungs 37. Each of the j-shaped members 20 forms an attachment to a riser 36 of ladder 41 as shown in FIGS. 2 and 3. Bolted connections can be provided for attaching each j-shaped member 20 to a ladder 41 riser 36 (see FIGS. 1-5). In FIG. 1, such a bolted connection can include the bolt 23 and nut 24. Similarly, a bolted connection can be used to attach each of the j-shaped members 20 to an elongated plate 18. Such a bolted connection can include bolt 25 and nut 26.

Openings 42 are provided at one end portion of each elongated plate 18 for enabling a bolt 25 to be attached to the plate 18 and j-shaped member 20 by passing through the aligned openings 22, 42, as shown in FIG. 1.

Clamp 13 is preferably hinged, providing hinge 27 that connects clamp sections 33, 35 together. Clamp opening 34 enables a bolted connection to be perfected when joining clamp 13 to bracket 15 using a bolt 25 and nut 26, as shown in FIG. 1. A pivotal connection 28 joins threaded member 29 to clamp 13. Threaded member 29 enables a nut 30 to be fastened thereto. Clamp section 33 provides a forked end portion 31 that is receptive of threaded member 29. When the threaded member 29 occupies the forked end 31 of clamp 13, nut 30 can be tightened for tightening the grip of clamp 13 about inclined or vertical member 12 of scaffolding 11. Threaded member 29 thus occupies slot 32 of forked end 13 in the clamping position.

The following is a list of parts and materials suitable for use in the present invention.

PARTS LIST

| Part Number | Description |
|---|---|
| 10 | ladder support apparatus |
| 11 | scaffolding |
| 12 | inclined or vertical member |
| 13 | clamp |
| 14 | bolted connection |
| 15 | laterally extended bracket |
| 16 | web |
| 17 | flange |
| 18 | elongated plate |
| 19 | slot |
| 20 | j-shaped member |
| 21 | opening |
| 22 | opening |
| 23 | bolt |
| 24 | nut |
| 25 | bolt |
| 26 | nut |
| 27 | hinge |
| 28 | pivotal connection |
| 29 | threaded member |
| 30 | nut |
| 31 | forked end |
| 32 | slot |
| 33 | clamp section |
| 34 | clamp opening |
| 35 | clamp section |
| 36 | riser |
| 37 | rung |
| 38 | horizontal member |
| 39 | flooring |
| 40 | frame |
| 41 | ladder |
| 42 | opening |

All measurements disclosed herein are at standard temperature and pressure, at sea level on Earth, unless indicated otherwise. All materials used or intended to be used in a human being are biocompatible, unless indicated otherwise.

The foregoing embodiments are presented by way of example only; the scope of the present invention is to be limited only by the following claims.

1. An adjustable ladder support apparatus comprising:
a) an adjustable frame that includes a pair of ladder clamps that enable the frame to be connected to the spaced apart risers of a ladder to be supported;
b) the frame including left and right plates;
c) a base plate opposite the clamps;
d) adjustable connections between the left and right plates and the base plate so that the distance between the base plate and the clamps can be varied; and
e) a clamp that is carried by the base plate for forming a connection between the frame and a vertical or inclined rigid support member.

2. The adjustable ladder support apparatus of claim 1 wherein the frame is generally rectangular.

3. The adjustable ladder support apparatus of claim 1 wherein the base plate forms adjustable connections at opposed base plate ends to the left and right side plates.

4. The adjustable ladder support apparatus of claim 1 wherein the support member is a section of scaffolding.

5. The adjustable ladder support apparatus of claim 1 further comprising a pair of ladder clamps that form a connection between the frame and a ladder.

6. The adjustable ladder support apparatus of claim 5 wherein the ladder clamps are pivotally attached to the frame.

7. The adjustable ladder support apparatus of claim 5 wherein each ladder clamp connects to a ladder riser.

8. The adjustable ladder support apparatus of claim 5 wherein the ladder clamps extend about one hundred eighty degrees around a ladder riser.

9. The adjustable ladder support apparatus of claim 1 wherein the frame has pivotal connections that enable the frame to pivot relative to either the ladder or the vertical or inclined rigid support member.

10. An adjustable ladder and scaffolding system, comprising:
a) a scaffolding structure;
b) a frame that includes a pair of ladder clamps that enable the frame to be connected to the spaced apart risers of a ladder to be supported;
c) the frame including left and right plates;
d) a base plate opposite the ladder clamps;
e) adjustable connections between the left and right plates and the base plate so that the distance between the base plate and the clamps can be varied; and
f) a scaffolding clamp that is carried by the base plate for forming a connection between the frame and the scaffolding structure.

11. The adjustable ladder support apparatus of claim 10 wherein the frame is generally rectangular.

12. The adjustable ladder support apparatus of claim 10 wherein the base plate forms adjustable connections at opposed base plate ends to the left and right side plates.

13. The adjustable ladder support apparatus of claim 1 wherein the scaffolding structure includes a plurality of vertical and horizontal members.

14. The adjustable ladder support apparatus of claim 10 further comprising a pair of ladder clamps that form a connection between the frame and a ladder.

15. The adjustable ladder support apparatus of claim 14 wherein the ladder clamps are pivotally attached to the frame.

16. The adjustable ladder support apparatus of claim 14 wherein each ladder clamp connects to a ladder riser.

17. The adjustable ladder support apparatus of claim 14 wherein the ladder clamps each extend at least about one hundred eighty degrees around a ladder riser.

18. The adjustable ladder support apparatus of claim 10 wherein the frame has pivotal connections that enable the frame to pivot relative to either the ladder or the vertical or inclined rigid support member.

19. The inventions substantially as shown and described herein.
